(19) United States
(12) Patent Application Publication
(10) Pub. No.: US 2025/0278616 A1
(43) Pub. Date: Sep. 4, 2025

(54) Processing Multimodal Prompts Using Text-Only Large Language Models

(71) Applicant: Google LLC, Mountain View, CA (US)

(72) Inventor: Quan Wang, Hoboken, NJ (US)

(73) Assignee: Google LLC, Mountain View, CA (US)

(21) Appl. No.: 19/053,356

(22) Filed: Feb. 13, 2025

Related U.S. Application Data
(60) Provisional application No. 63/559,395, filed on Feb. 29, 2024.

(51) Int. Cl. G06N 3/0495; G06F 40/242; G06N 3/08

(52) U.S. Cl. CPC G06N 3/0495; G06F 40/242; G06N 3/08

(57) ABSTRACT

A multimodal system includes a multimodal encoder, a vector quantization model, and a text-only large language model (LLM). The multimodal encoder is configured to receive, as input, a multimodal input for a prompt, and generate, based on the multimodal input, a sequence of embeddings. The vector quantization model is configured to receive, as input, the sequence of embeddings generated by the multimodal encoder, and generate, based on the sequence of embeddings, a sequence of textual tokens. The text-only LLM is configured to receive, as input text, a natural language command for the prompt and the sequence of textual tokens generated by the vector quantization model, and generate, based on the natural language command and the sequence of textual tokens, a corresponding textual output.

### CROSS REFERENCE TO RELATED APPLICATIONS

This U.S. patent application claims priority under 35 U.S.C. § 119 (e) to U.S. Provisional Patent Application No. 63/559,395, filed on Feb. 29, 2024. The disclosure of this prior application is considered part of the disclosure of this application and is hereby incorporated by reference in its entirety.

### TECHNICAL FIELD

This disclosure relates to processing multimodal prompts using text-only large language models (LLMs).

### BACKGROUND

A large language model (LLM) is an advanced artificial intelligence (AI) system designed to understand, generate, and manipulate human language inputs (i.e., textual inputs) with a high degree of accuracy and fluency. LLMs are utilized in a wide array of applications, including but not limited to, natural language processing (NLP) or natural language understanding (NLU) tasks such as text generation, translation, summarization, and sentiment analysis. LLMs are also employed in conversational agents, digital assistants, virtual assistants, and customer service chatbots to provide human-like interactions. Additionally, LLMs are instrumental in content creation, idea generation, and text drafting, as well as in educational tools that offer personalized learning experiences. Their versatility and ability to handle complex language-based tasks make LLMs invaluable in both personal, commercial, and research settings.

### SUMMARY

One aspect of the disclosure provides a multimodal system including a multimodal encoder, a vector quantization model, and a text-only large language model (LLM). The multimodal encoder is configured to receive, as input, a multimodal input for a prompt, and generate, based on the multimodal input, a sequence of embeddings. The vector quantization model is configured to receive, as input, the sequence of embeddings generated by the multimodal encoder, and generate, based on the sequence of embeddings, a sequence of textual tokens. The monomodal LLM is configured to receive, as input text, a natural language command for the prompt and the sequence of textual tokens generated by the vector quantization model, and generate, based on the natural language command and the sequence of textual tokens, a corresponding textual output.

Implementations of the disclosure may include one or more of the following optional features. In some implementations, the multimodal input includes at least one of an audio input including audio data corresponding to a spoken utterance, or an image input including image data. The corresponding textual output may include at least one of a transcription of the audio input corresponding to the spoken utterance, or a corresponding classification or identification of one or more objects from the image input.

In some examples, each textual token of the sequence of textual tokens includes a respective American Standard Code for Information Interchange (ASCII) character. In some implementations, the multimodal encoder includes at least one of a trained audio encoder configured to generate a sequence of audio embeddings based on an audio input, or a trained image encoder configured to generate a sequence of image embeddings based on an image input.

In some implementations, the vector quantization model generates the sequence of textual tokens based on the sequence of embeddings using a dictionary of textual tokens. The vector quantization model may map each embedding of the sequence of embeddings to a respective textual token using the dictionary of textual tokens. The vector quantization model may be trained on a plurality of multimodal training samples by, for each multimodal training sample of the plurality of multimodal training samples, generating, using the multimodal encoder, a corresponding sequence of embeddings based on the multimodal training sample, and generating a dictionary of textual tokens based on the corresponding sequence of embeddings generated for each respective multimodal training sample of the plurality of multimodal training samples, wherein each corresponding embedding is mapped to a respective one of the textual tokens from the dictionary of textual tokens. Generating the dictionary of textual tokens may include determining a respective embedding frequency of each corresponding embedding generated from the plurality of multimodal training samples, determining a respective token frequency of each textual token from the dictionary, and mapping each corresponding embedding to a respective one of the textual tokens from the dictionary of textual tokens based on the respective embedding frequency of each corresponding embedding and the respective token frequency of each textual token from the dictionary. In some examples, the text-only LLM is fine-tuned on a plurality of multimodal training samples by updating trainable parameters of the text-only LLM while trained parameters of the text-only LLM remain frozen.

Another aspect of the disclosure provides a computer-implemented method including receiving, as input to a multimodal system, a natural language command and a multimodal input, the natural language command requesting a particular textual output based on the multimodal input. The method also includes generating, by a multimodal encoder of the multimodal system, based on the multimodal input, a sequence of embeddings. The method further includes generating, by a vector quantization model of the multimodal system, based on the sequence of embeddings generated by the multimodal encoder, a sequence of textual tokens. The method additionally includes generating, by a text-only large language model (LLM) of the multimodal system, based on the natural language command and the sequence of textual tokens generated by the vector quantization model, a corresponding textual output.

Implementations of the disclosure may include one or more of the following optional features. In some implementations, the multimodal input includes at least one of an audio input including audio data corresponding to a spoken utterance, or an image input including image data. The corresponding textual output may include at least one of a transcription of the audio input corresponding to the spoken utterance, or a corresponding classification or identification of one or more objects from the image input.

In some examples, each textual token of the sequence of textual tokens includes a respective American Standard Code for Information Interchange (ASCII) character. In some implementations, the multimodal encoder includes at least one of a trained audio encoder configured to generate a sequence of audio embeddings based on an audio input, or a trained image encoder configured to generate a sequence of image embeddings based on an image input.

In some implementations, the vector quantization model generates the sequence of textual tokens based on the sequence of embeddings using a dictionary of textual tokens. The vector quantization model may map each embedding of the sequence of embeddings to a respective textual token using the dictionary of textual tokens. The vector quantization model may be trained on a plurality of multimodal training samples by, for each multimodal training sample of the plurality of multimodal training samples, generating, using the multimodal encoder, a corresponding sequence of embeddings based on the multimodal training sample, and generating a dictionary of textual tokens based on the corresponding sequence of embeddings generated for each respective multimodal training sample of the plurality of multimodal training samples, wherein each corresponding embedding is mapped to a respective one of the textual tokens from the dictionary of textual tokens. Generating the dictionary of textual tokens may include determining a respective embedding frequency of each corresponding embedding generated from the plurality of multimodal training samples, determining a respective token frequency of each textual token from the dictionary, and mapping each corresponding embedding to a respective one of the textual tokens from the dictionary of textual tokens based on the respective embedding frequency of each corresponding embedding and the respective token frequency of each textual token from the dictionary. In some examples, the text-only LLM is fine-tuned on a plurality of multimodal training samples by updating trainable parameters of the text-only LLM while trained parameters of the text-only LLM remain frozen.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example multimodal system having a text-only large language model (LLM).

FIG. 2 illustrates an example dictionary of textual tokens.

FIG. 3 is a flowchart of an example arrangement of operations for a computer-implemented method of processing multimodal prompts using a text-only LLM.

FIG. 4 is a schematic view of an example computing device that may be used to implement the systems and methods described herein.

Like reference symbols in the various drawings indicate like elements.

### DETAILED DESCRIPTION

A large language model (LLM) is an advanced artificial intelligence (AI) system designed to understand, generate, and manipulate human language inputs (i.e., textual inputs) with a high degree of accuracy and fluency. LLMs are utilized in a wide array of applications, including but not limited to, natural language processing (NLP) or natural language understanding (NLU) tasks such as text generation, translation, summarization, and sentiment analysis. LLMs are also employed in conversational agents, digital assistants, virtual assistants, and customer service chatbots to provide human-like interactions. Additionally, LLMs are instrumental in content creation, idea generation, and text drafting, as well as in educational tools that offer personalized learning experiences. Their versatility and ability to handle complex language-based tasks make LLMs invaluable in both personal, commercial, and research settings. However, conventional LLMs are monomodal and can only process textual inputs (i.e., text-based inputs) and only generate and output textual outputs (i.e., text-based outputs), which may limit their usefulness. Therefore, there is a need for processing prompts including multimodal inputs (e.g., including text, audio and/or images) using text-only LLMs (e.g., LLMs that can only process textual inputs and only generate textual outputs). Implementations disclosed herein are directed toward techniques for processing multimodal input prompts using text-only LLMs that are trained to only process textual inputs and generate textual outputs.

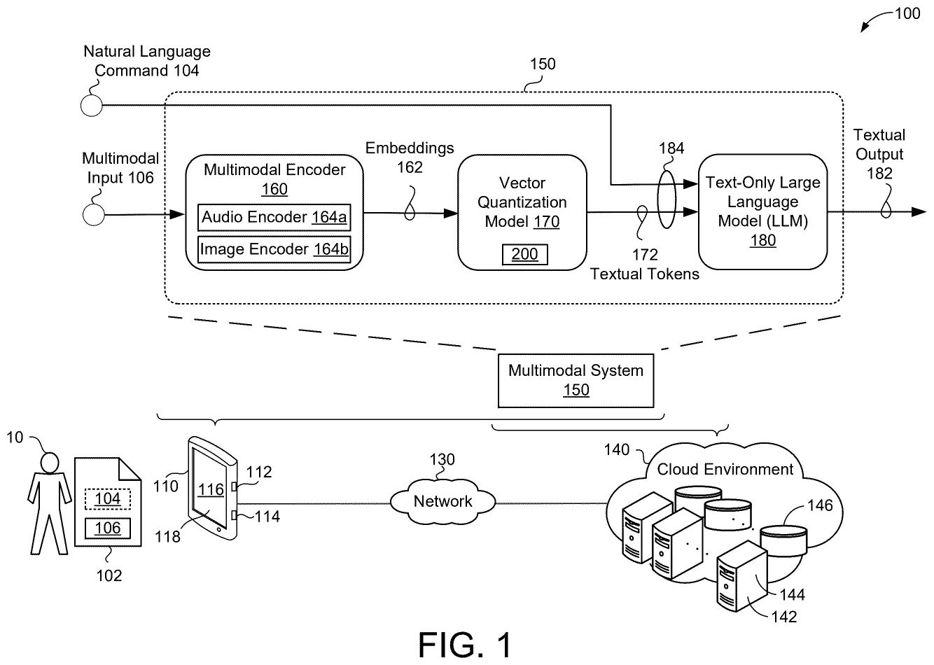

FIG. 1 is a schematic view of an example of a system 100 having a multimodal system 150 for interacting with a user 10. In the example shown, a user device 110 associated with the user 10 presents a user interface 116 on a display 118 of the user device 110. The user interface 116 enables the user 10 to interact with the multimodal system 150 in, for example, a query-answer, a conversational, a back-and-forth, or a turn taking manner. In particular, during an interaction between the user 10 and the multimodal system 150, the user provides a multimodal input 106 for a prompt 184 and the LLM 180 receives a natural language command 108 for the prompt 184 that specifies a task for the LLM 180 to perform based on the multimodal input 106. In particular, the natural language command 104 requests the LLM 180 to generate, as output, a textual output response 182 based on the multimodal input 106. The natural language command 108 may include natural language text. In some examples, the user 10 provides the natural language command 104 when providing the multimodal input 106. In other examples, the LLM 180 receives the natural language command 104 as a preconfigured setting to instruct the LLM 180 to perform the task specified by the natural language command 104 based on each multimodal input 106 provided by the user 10. In some scenarios, the natural language command 104 specifying the task for the LLM 180 to perform is selected based on the type of multimodal input 106. For instance, when the multimodal input 106 includes an audio input 106, a natural language command 104 of “transcribe this audio” may be selected and provided as input to the LLM 180 to prompt the LLM 180 to transcribe the audio input. Similarly, when the multimodal input 106 includes an image input 106, a natural language command 104 of “describe this image” may be selected and provided as input to the LLM 180 to prompt the LLM 180 to generate a textual output response 182 that conveys a description of the image input 106.

The user device 110 may correspond to any computing device associated with a user 10. Some examples of user devices 110 include, but are not limited to, mobile devices (e.g., mobile phones, tablets, laptops, etc.), computers, wearable devices (e.g., a smart watch, smart glasses, smart goggles, an AR headset, a VR headset, etc.), smart appliances, Internet of things (IoT) devices, vehicle infotainment systems, smart displays, smart speakers, etc. The user device 110 includes the display 118, data processing hardware 112, and memory hardware 114 in communication with the data processing hardware 112. The memory hardware 114 stores instructions that, when executed by the data processing hardware 112, cause the data processing hardware 112 to perform one or more operations. The user device 110 further includes any number and/or type(s) of input/output devices (not shown for clarity of illustration) for receiving inputs (e.g., the prompt 102, the natural language command 104, and the multimodal input 106). The input/output devices may reside on or be in communication with the user device 110.

The multimodal system 150 may execute on the user device 110 and/or on a remote computing system 140 in communication with the user device 110 via a network 130. In the illustrated example, the remote computing system 140 is a distributed system (e.g., cloud computing environment) having scalable/elastic resources 142. The resources 142 include computing resources 144 (e.g., data processing hardware) and/or storage resources 146 (e.g., memory hardware). However, other types of remote computing systems 140 may be used to execute the multimodal system 150.

The multimodal system 150 is configured to process multimodal inputs 106 using a text-only LLM 180 (also referred to herein as LLM 180). The multimodal system 150 includes a multimodal encoder 160, a vector quantization model 170, and the LLM 180. Here, the LLM 180 is configured to only receive textual inputs (i.e., text-based inputs) and to only generate textual outputs (i.e., text-based outputs). That is, the LLM 180 is monomodal and pre-trained on text-only data to provides a blackbox text-in text-out interface.

The multimodal encoder 160 is configured to receive different modalities of inputs 106 (e.g., audio, image or video inputs) and to generate different modalities of embeddings 162 by encoding the inputs 106. In particular, the multimodal encoder 160 is configured to receive, as input, a multimodal input 106 (i.e., an input 106 that can have any of multiple modalities, such as audio or image) for a prompt 184 directed toward the LLM 180, and generate, based on the multimodal input 106, a corresponding sequence of embeddings 162. The multimodal encoder 160 may include any number and/or type(s) of encoders 164, 164a-n. For example, the multimodal encoder 160 may include a trained audio encoder 164a configured to generate, based on an audio input 106, a sequence of one or more audio embeddings 162. Here the audio input 106 may include audio data characterizing a spoken utterance and a resultant textual output 182 may be a transcription of the spoken utterance. Additionally, or alternatively, the multimodal encoder 160 may include a trained image encoder 164b configured to generate, based on an image input 106 including image data, a sequence of one or more image embeddings 162. Here, a resultant textual output 182 for the image input 106 may be a corresponding classification or identification of one or more objects in the image input 106. The multimodal encoder 160 may also include other types of encoders 164 for generating other types of embeddings 162. In some examples, the embeddings 162 are multimodal embeddings 162 representing an input 106 having two or more modalities.

The vector quantization model 170 is configured to receive, as input, the sequence of embeddings 162 generated by the multimodal encoder 160, and generate, based on the sequence of embeddings 162, a sequence of textual tokens 172. In some implementations, the vector quantization model 170 generates the sequence of textual tokens 172 for a sequence of embeddings 162 using a dictionary 200 of textual tokens. In particular, the vector quantization model 170 may map, using the dictionary 200 of textual tokens, each embedding 162 of the sequence of embeddings 162 to a corresponding textual token 172. In some examples, each textual token 172 of a sequence of textual tokens 172 generated by the vector quantization model 170 one or more American Standard Code for Information Interchange (ASCII) characters. The sequence of textual tokens 172 are then input, together with the natural language command 104, to the LLM 180 as a text-only input prompt 184.

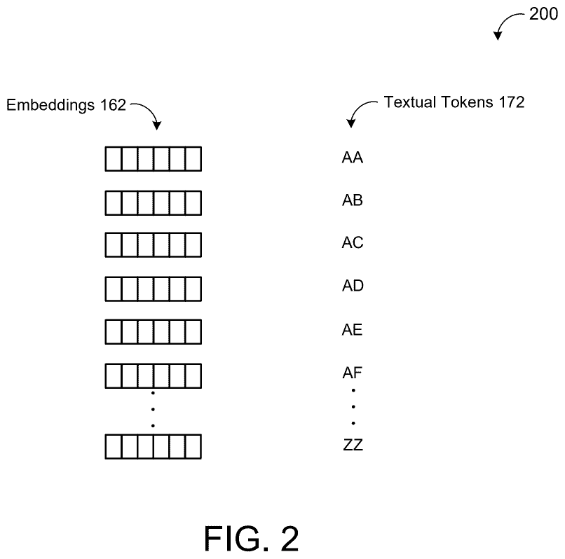

FIG. 2 illustrates an example dictionary 200 that may be used to map embeddings 162 to textual tokens 172. In particular, the dictionary 200 may be used to look up, for each of the embeddings 162, a corresponding textual token 172. Each textual token may include one or more respective ASCII characters.

Returning to FIG. 1, the multimodal encoder 160 and the vector quantization model 170 collectively operate to represent the multimodal input 106 as a sequence of textual tokens 172 (e.g., ASCII characters) that can be directly input, together with the natural language command 104, to the text-only LLM 180 as a text-only input prompt 184. For example, the user 10 may speak “hello” as an audio input 106 captured by the user device 110 and the LLM 180 may receive a natural language command 104 of “transcribe this audio”. The multimodal encoder 160 and the vector quantization model 170 collectively generate, based on the spoken utterance “hello,” a string of ASCII characters 172, such as “E7 OF KC GO 4V K0 4I B5.” Here, a textual input prompt 184 for the LLM 180 is “transcribe this audio: E7 OF KC GO 4V K0 4I B5,” to which the LLM 180 responds with a textual output 182 of “hello.” The multimodal encoder 160 and the vector quantization model 170 can similarly operate to represent other types of multimodal inputs 106 as a sequence of textual tokens 172. Here, in effect, the multimodal system 150 is trained and/or configured to translate a multimodal input 106 into a new textual language where multimodal inputs 106 are represented by strings of printable ASCII characters or other types of characters or scripts. The LLM 180 can be trained or fine-tuned to transliterate the script conveyed by the textual tokens into a different script, such as English. Notably, the user 10 need not explicitly provide the natural language command 104 together with the multimodal input 106. For instance, the natural language command 104 may be a preconfigured setting that specifies a type of task for the LLM 180 to perform and/or the LLM 180 is leveraged by an application for performing the task specified by the natural language command 180. Of course, the user could directly provide the natural language command 104 of “transcribe this audio” and upload an audio file as an audio input 106 to be transcribed.

In some implementations, the vector quantization model 170 is trained by a training process using a plurality of multimodal training samples. Here, the training process may generate, for each multimodal training sample of the plurality of multimodal training samples, using the multimodal encoder 160, a corresponding sequence of embeddings 162 based on the multimodal training sample. The training process may then generate the dictionary 200 of textual tokens 172 based on the corresponding sequence of embeddings 162 generated for each respective multimodal training sample of the plurality of multimodal training samples. Here, each corresponding embedding 162 is mapped to a respective one of the textual tokens 172 from the dictionary 200 of textual tokens.

The text-only LLM 180 is configured to receive, as a text-only input prompt 184, the natural language command 104 and the sequence of textual tokens 172 generated by the vector quantization model 170 as a new text-only language representation of the multimodal input 106. The LLM 180 generates, based on the text-only input prompt 184 including the natural language command 104 conditioned on the textual tokens 172, a corresponding textual output 182 for the prompt 184.

In some examples, the training process also trains or fine-tunes the LLM 180 based on the plurality of multimodal training samples by updating trainable parameters of the LLM 180 while trained parameters of the LLM 180 remain frozen. Here, the training process trains the LLM 180 to learn the new language representation of multimodal inputs 106 as a string of textual tokens 172 and to translate or transliterate the script of the textual tokens 172 into a different script or language, such as English.

In particular, the training process may train the multimodal system 150 using encoders 164 that were pre-trained using self-supervised learning to represent multimodal inputs 106 by a sequence of embeddings 162. Example encoders 164 include, but are not limited to, a wav2vec2 model or bidirectional encoder representation from transformers (BERT)-based Speech pre-Training with Random-projection Quantizer (BEST-RQ) for audio, and a bidirectional encoder representation from image transformers (BEIT) model for images.

Based on embeddings 162 generated by the encoders 164 for each of the plurality of multimodal training samples, the training process builds a dictionary of embeddings. The training process then uses vector quantization (e.g., k-means clustering) to represent each embedding of the dictionary of embeddings by a corresponding identifier ID, such that each multimodal input of the plurality of multimodal training samples is represented by a sequence of IDs.

The training process then builds a map such that each ID is uniquely represented by a printable ASCII character, or a sequence of printable ASCII characters (e.g., two ASCII characters), optionally separated by a special character (e.g. a space or comma). In some examples, to build this map, the training process computes a corresponding frequency of each ID in the plurality of multimodal training samples, and computes a corresponding frequency of each printable ASCII character in a text corpora. The training process then maps the IDs to ASCII characters, such that more frequent IDs are mapped to more frequent ASCII characters.

Using the ID-to-ASCII mapping, the training process then represents each audio/image of the plurality of multimodal training samples by a sequence of textual tokens. The training process then directly injects those sequences of textual tokens into natural language instructions to build a training dataset for fine-tuning or training the LLM 180 for performing various tasks, such as automatic speech recognition and image recognition, based the new language representation of multimodal inputs.

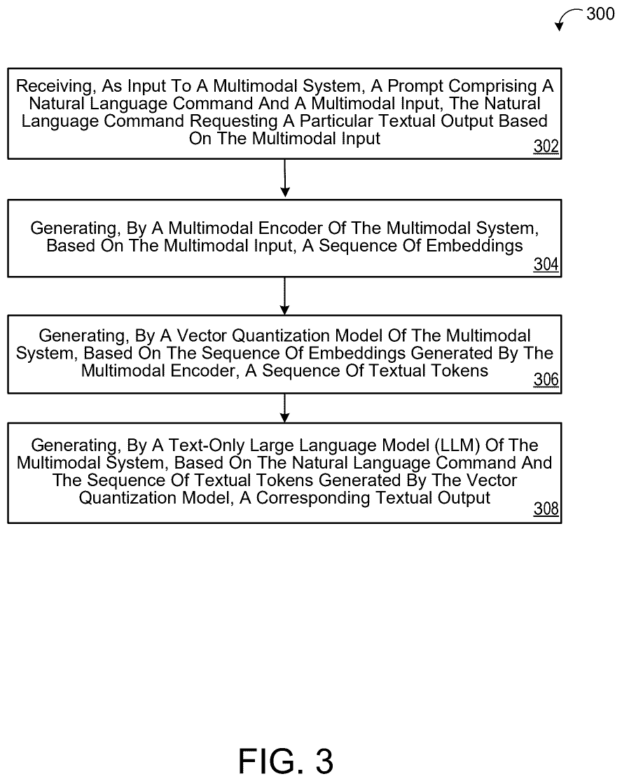

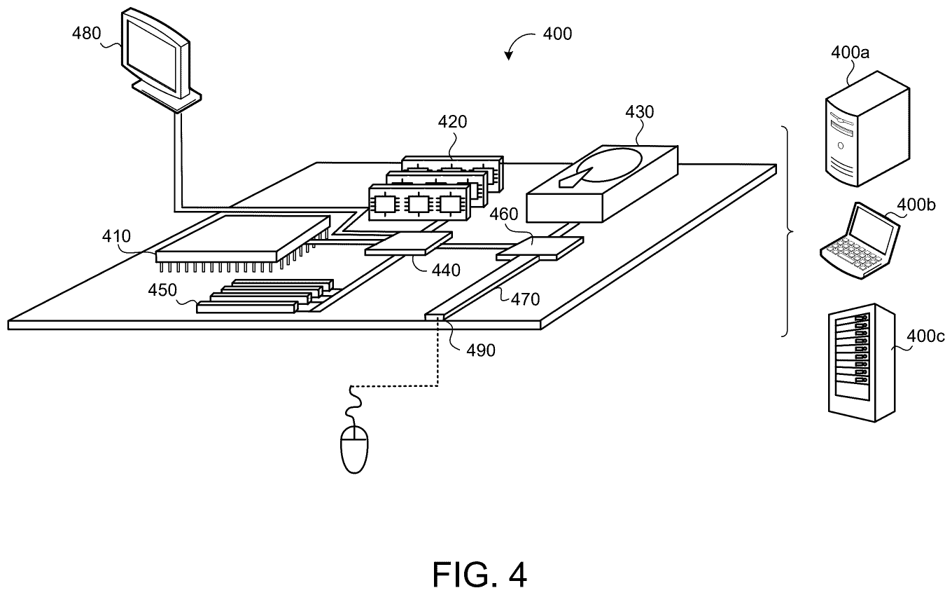

FIG. 3 is a flowchart of an example arrangement of operations for a computer-implemented method 300 of using the LLM 180 for processing a multimodal input prompt 102. The operations may be performed by data processing hardware 410 (FIG. 4) (e.g., the data processing hardware 112 of the user device 110 or the data processing hardware 142 of the remote computing system 140) based on executing instructions stored on memory hardware 420 (e.g., the memory hardware 114 of the user device 110 or the memory hardware 144 of the remote computing system 140). Many other ways of implementing the method 300 may be employed. For example, the order of execution of the operations may be changed, and/or one or more of the operations and/or interactions may be changed, eliminated, sub-divided, or combined. Additionally, the operations of FIG. 3 may be carried out sequentially and/or in parallel by, for example, separate processing threads, processors, devices, discrete logic, circuits, etc.

At operation 302, the method 300 includes receiving, as input to a multimodal system 150, a prompt 184 including a natural language command 104 and a multimodal input 106. The natural language command 104 requests a particular textual output 182 based on the multimodal input 106. At operation 304, the method 300 includes generating, by a multimodal encoder 160 of the multimodal system 150, based on the multimodal input 106, a sequence of embeddings 162.

At operation 306, the method 300 includes generating, by a vector quantization model 170 of the multimodal system 150, based on the sequence of embeddings 162 generated by the multimodal encoder 160, a sequence of textual tokens 172. At operation 308, the method 300 includes generating, by a text-only LLM 180 of the multimodal system 150, based on the natural language command 104 and the sequence of textual tokens 172 generated by the vector quantization model 170, a corresponding textual output 182.

FIG. 4 is schematic view of an example computing device 400 that may be used to implement the systems and methods described in this document. The computing device 400 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 400 includes a processor 410 (i.e., data processing hardware) that can be used to implement the data processing hardware 112 and/or 142, memory 420 (i.e., memory hardware) that can be used to implement the memory hardware 114 and/or 144, a storage device 430 (i.e., memory hardware) that can be used to implement the memory hardware 114 and/or 144, a high-speed interface/controller 440 connecting to the memory 420 and high-speed expansion ports 450, and a low speed interface/controller 460 connecting to a low speed bus 470 and a storage device 430 that can be used to store a conversational training dataset. Each of the components 410, 420, 430, 440, 450, and 460, are interconnected using various busses, and may be mounted on a common motherboard or in other manners as appropriate. The processor 410 can process instructions for execution within the computing device 400, including instructions stored in the memory 420 or on the storage device 430 to display graphical information for a graphical user interface (GUI) on an external input/output device, such as display 480 coupled to high speed interface 440. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 420 stores information non-transitorily within the computing device 400. The memory 420 may be a computer-readable medium, a volatile memory unit(s), or non-volatile memory unit(s). The non-transitory memory 420 may be physical devices used to store programs (e.g., sequences of instructions) or data (e.g., program state information) on a temporary or permanent basis for use by the computing device 400. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 430 is capable of providing mass storage for the computing device 400. In some implementations, the storage device 430 is a computer-readable medium. In various different implementations, the storage device 430 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 420, the storage device 430, or memory on processor 410.

The high speed controller 440 manages bandwidth-intensive operations for the computing device 400, while the low speed controller 460 manages lower bandwidth-intensive operations. Such allocation of duties is exemplary only. In some implementations, the high-speed controller 440 is coupled to the memory 420, the display 480 (e.g., through a graphics processor or accelerator), and to the high-speed expansion ports 450, which may accept various expansion cards (not shown). In some implementations, the low-speed controller 460 is coupled to the storage device 430 and a low-speed expansion port 490. The low-speed expansion port 490, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 400a or multiple times in a group of such servers 400a, as a laptop computer 400b, or as part of a rack server system 400c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

These computer programs (also known as programs, software, software applications, or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Unless expressly stated to the contrary, the phrase “at least one of A, B, or C” is intended to refer to any combination or subset of A, B, C such as: (1) at least one A alone; (2) at least one B alone; (3) at least one C alone; (4) at least one A with at least one B; (5) at least one A with at least one C; (6) at least one B with at least C; and (7) at least one A with at least one B and at least one C. Moreover, unless expressly stated to the contrary, the phrase “at least one of A, B, and C” is intended to refer to any combination or subset of A, B, C such as: (1) at least one A alone; (2) at least one B alone; (3) at least one C alone; (4) at least one A with at least one B; (5) at least one A with at least one C; (6) at least one B with at least one C; and (7) at least one A with at least one B and at least one C. Furthermore, unless expressly stated to the contrary, “A or B” is intended to refer to any combination of A and B, such as: (1) A alone; (2) B alone; and (3) A and B.

A number of implementations have been described. Nevertheless, it will be understood that various modifications may be made without departing from the spirit and scope of the disclosure. Accordingly, other implementations are within the scope of the following claims.

What is claimed is:

1. A multimodal system comprising:
a multimodal encoder configured to:
receive, as input, a multimodal input for a prompt; and
generate, based on the multimodal input, a sequence of embeddings;
a vector quantization model configured to:
receive, as input, the sequence of embeddings generated by the multimodal encoder; and
generate, based on the sequence of embeddings, a sequence of textual tokens; and
a text-only large language model (LLM) configured to:
receive, as input text, a natural language command for the prompt and the sequence of textual tokens generated by the vector quantization model; and
generate, based on the natural language command and the sequence of textual tokens, a corresponding textual output.

2. The multimodal system of claim 1, wherein the multimodal input comprises at least one of:
an audio input comprising audio data corresponding to a spoken utterance; or
an image input comprising image data.

3. The multimodal system of claim 2, wherein the corresponding textual output comprises at least one of:
a transcription of the audio input corresponding to the spoken utterance; or
a corresponding classification or identification of one or more objects from the image input.

4. The multimodal system of claim 1, wherein each textual token of the sequence of textual tokens comprises a respective American Standard Code for Information Interchange (ASCII) character.

5. The multimodal system of claim 1, wherein the multimodal encoder comprises at least one of:
a trained audio encoder configured to generate a sequence of audio embeddings based on an audio input; or
a trained image encoder configured to generate a sequence of image embeddings based on an image input.

6. The multimodal system of claim 1, wherein the vector quantization model generates the sequence of textual tokens based on the sequence of embeddings using a dictionary of textual tokens.

7. The multimodal system of claim 6, wherein the vector quantization model maps each embedding of the sequence of embeddings to a respective textual token using the dictionary of textual tokens.

8. The multimodal system of claim 6, wherein the vector quantization model is trained on a plurality of multimodal training samples by:
for each multimodal training sample of the plurality of multimodal training samples, generating, using the multimodal encoder, a corresponding sequence of embeddings based on the multimodal training sample; and
generating a dictionary of textual tokens based on the corresponding sequence of embeddings generated for each respective multimodal training sample of the plurality of multimodal training samples, wherein each corresponding embedding is mapped to a respective one of the textual tokens from the dictionary of textual tokens.

9. The multimodal system of claim 8, wherein generating the dictionary of textual tokens comprises:
determining a respective embedding frequency of each corresponding embedding generated from the plurality of multimodal training samples;
determining a respective token frequency of each textual token from the dictionary; and
mapping each corresponding embedding to a respective one of the textual tokens from the dictionary of textual tokens based on the respective embedding frequency of each corresponding embedding and the respective token frequency of each textual token from the dictionary.

10. The multimodal system of claim 1, wherein the text-only LLM is fine-tuned on a plurality of multimodal training samples by updating trainable parameters of the text-only LLM while trained parameters of the text-only LLM remain frozen.

11. A computer-implemented method executed on data processing hardware that causes the data processing hardware to perform operations comprising:
receiving, as input to a multimodal system, a natural language command and a multimodal input, the natural language command requesting a particular textual output based on the multimodal input;
generating, by a multimodal encoder of the multimodal system, based on the multimodal input, a sequence of embeddings;
generating, by a vector quantization model of the multimodal system, based on the sequence of embeddings generated by the multimodal encoder, a sequence of textual tokens; and
generating, by a text-only large language model (LLM) of the multimodal system, based on the natural language command and the sequence of textual tokens generated by the vector quantization model, a corresponding textual output.

12. The method of claim 11, wherein the multimodal input comprises at least one of:
an audio input comprising audio data corresponding to a spoken utterance; or
an image input comprising image data.

13. The method of claim 12, wherein the corresponding textual output comprises at least one of:
a transcription of the audio input corresponding to the spoken utterance; or
a corresponding classification or identification of one or more objects from the image input.

14. The method of claim 11, wherein each textual token of the sequence of textual tokens comprises a respective American Standard Code for Information Interchange (ASCII) character.

15. The method of claim 11, wherein the multimodal encoder comprises at least one of:
a trained audio encoder configured to generate a sequence of audio embeddings based on an audio input; or
a trained image encoder configured to generate a sequence of image embeddings based on an image input.

16. The method of claim 11, wherein the vector quantization model generates the sequence of textual tokens based on the sequence of embeddings using a dictionary of textual tokens.

17. The method of claim 16, wherein the vector quantization model maps each embedding of the sequence of embeddings to a respective textual token using the dictionary of textual tokens.

18. The method of claim 16, wherein the vector quantization model is trained on a plurality of multimodal training samples by:
for each multimodal training sample of the plurality of multimodal training samples, generating, using the multimodal encoder, a corresponding sequence of embeddings based on the multimodal training sample; and
generating a dictionary of textual tokens based on the corresponding sequence of embeddings generated for each respective multimodal training sample of the plurality of multimodal training samples, wherein each corresponding embedding is mapped to a respective one of the textual tokens from the dictionary of textual tokens.

19. The method of claim 18, wherein generating the dictionary of textual tokens comprises:
determining a respective embedding frequency of each corresponding embedding generated from the plurality of multimodal training samples;
determining a respective token frequency of each textual token from the dictionary; and
mapping each corresponding embedding to a respective one of the textual tokens from the dictionary of textual tokens based on the respective embedding frequency of each corresponding embedding and the respective token frequency of each textual token from the dictionary.

20. The method of claim 11, wherein the text-only LLM is fine-tuned on a plurality of multimodal training samples by updating trainable parameters of the text-only LLM while trained parameters of the text-only LLM remain frozen.
